(19) United States
(12) Patent Application Publication
(10) Pub. No.: US 2012/0042832 A1
(43) Pub. Date: Feb. 23, 2012

(54) Betta Fish Protectors for Aquariums

(76) Inventor: Karen Trisel, Ohio City, OH (US)

(21) Appl. No.: 13/160,582

(22) Filed: Jun. 15, 2011

Related U.S. Application Data
(60) Provisional application No. 61/374,411, filed on Aug. 17, 2010.

(51) Int. Cl. A01K 63/00

(52) U.S. Cl. 119/248

(57) ABSTRACT

An architecture is presented for a device that enables a user to accommodate a number of betta fish, or betta fish and other fish species, in a segregated manner in a single aquarium for a prolonged period of time. More specifically, the device, among other things, enables an aquarium owner or user to partition said aquarium in such a manner as to permit the water contained within the aquarium to pass freely through said partition, while at the same time prohibiting the fish within the aquarium from doing the same.

### CROSS-REFERENCE

This application claims priority from Provisional Patent Application Serial No. 61/374,411 filed Aug. 17, 2010.

### BACKGROUND

Many individuals enjoy keeping different species of fish, such as betta fish, as pets in their homes, offices and the like. Betta fish are beautiful, vibrant fish that can be enjoyed by persons of all ages. However, betta fish also tend to be somewhat aggressive when kept in captivity with other betta fish and/or other species of fish. Therefore, it is oftentimes necessary to keep betta fish separate and apart from each other and/or other fish. Most pet stores keep betta fish in small containers or tubs of water, which is oftentimes of poor quality due to the lack of proper filtration, plant life and temperature control, which can lead to a shortened lifespan for the betta fish. Moreover, the problem is exasperated by the fact that most pet stores simply sell their betta fish to customers in the same small containers with poor water quality in which they are stored in the pet store. Consequently, most purchasers of betta fish simply continue to use the same container in which the fish was purchased, which lacks the proper filtration, plant life and temperature control, after they take their betta fish home which further contributes to the shortened life span of most betta fish kept in captivity.

Heretofore one solution to the existing problem of storing, selling and maintaining betta and other somewhat aggressively natured fish in small containers with poor water quality, filtration and temperature control has been to utilize larger tanks with proper filtration, plant life, temperature control and overall better water quality. However, due to the somewhat aggressive nature of the betta fish, it is not feasible to store large quantities of betta fish in the same tank or aquarium, or with other species of fish. Therefore, in order to maintain a large number of betta or other aggressively natured fish, and/or multiple species of fish, a user would need multiple fish tanks or containers, each containing a relatively small number of betta fish or each containing a different species of fish, which can be expensive and require large amounts of space. Moreover, each of the forgoing multiple tanks would need to be equipped with the proper filtration, plant life, temperature control equipment etc. to maintain a suitable environment for the fish, which further adds to the overall cost of maintaining and caring for the fish which is undesirable and may discourage individuals from keeping fish, such as betta fish, as pets.

Consequently, there exists in the art a long-felt need for a device that enables a pet owner or pet store to accommodate a number of betta fish, or betta fish and other fish species, in a segregated manner in a single fish tank for a prolonged period of time. There also exists a long-felt need for a device that accomplishes the forgoing objectives and that is relatively easy and inexpensive to manufacture and use. Finally, there is a long-felt need for a device that accomplishes all of the forgoing objectives and that can be retrofitted to existing fish tanks and aquariums.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a device that enables a pet owner or pet store to accommodate a number of betta or other aggressively natured fish, or said fish with other fish species, in a segregated manner in a single fish tank for a prolonged period of time. In a preferred embodiment of the present invention, the device comprises at least one support removably attached to the bottom portion of an aquarium or tank and at least one column further comprising a column wall for partitioning the aquarium into a column interior portion and a column exterior portion. Each column wall further comprises an exterior surface and an interior surface and at least one opening located in the column wall that extends between said exterior surface and said interior surface. The opening not only prevents the fish located within the column exterior portion from accessing the column interior portion and vice versa, but it also permits the water in the aquarium, and the oxygen associated therewith, to flow freely from the column exterior portion to the column interior portion and vice versa. Moreover, the column wall may be constructed of a substantially transparent material such that the fish within the aquarium can interact with one another although on opposite sides of the column wall, and to enable aquarium users to enjoy watching their fish even when said fish are located in the column interior portion of said aquarium.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of one embodiment of the device of the present invention.

FIG. 2 illustrates a perspective view of two different embodiments of a support for a column, each attached to a bottom surface of an aquarium shown in partial view.

FIG. 3 illustrates a perspective view of an alternative embodiment of the device of the present invention.

FIG. 4 illustrates a perspective view of two different embodiments of the present invention contained within an aquarium, wherein said aquarium is resting atop a stand.

FIG. 5 illustrates a partial front elevational view of an embodiment of the device of the present invention contained within an aquarium, wherein said aquarium is resting atop a stand.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

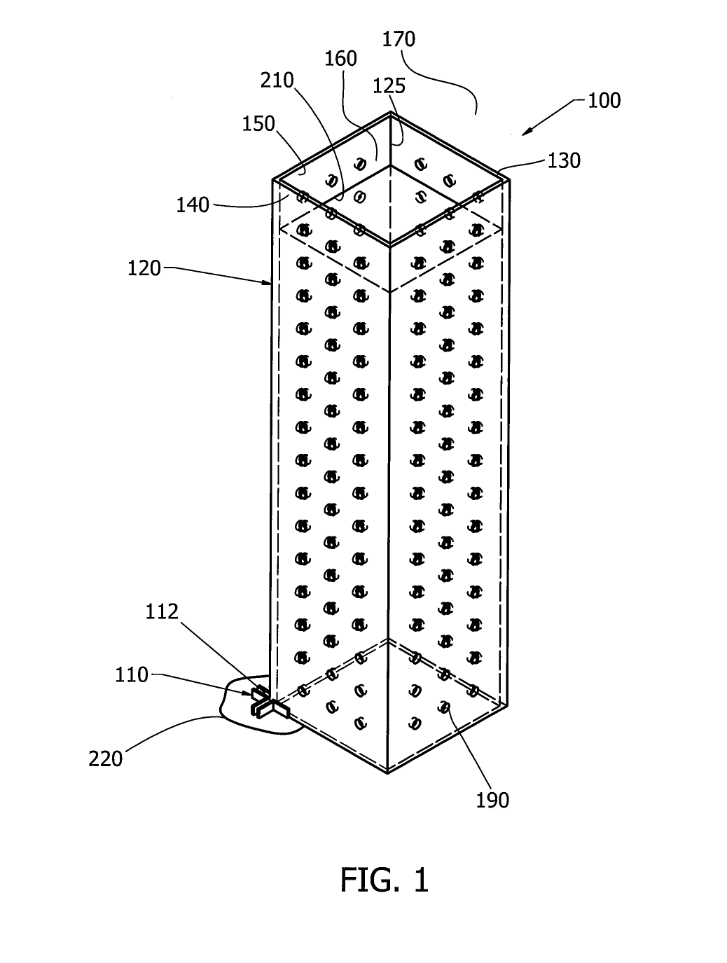

Referring initially to the drawings, FIG. 1 illustrates one embodiment of a device 100 for partitioning a portion of an aquarium to separate aggressively natured fish, including betta fish, while allowing the water within the aquarium to also be enjoyed by the fish within the partitioned space. The device 100 preferably comprises at least one support 110 and at least one column 120. Column 120 further comprises a continuous opening therein 125 and a column wall 130 for partitioning an aquarium or tank into a column interior portion 160 and a column exterior portion 170. In FIG. 1, the cross section of column 120 is substantially rectangular, though it is contemplated that the cross section could take on virtually any geometric or non-geometric shape without affecting the overall concept of the invention.

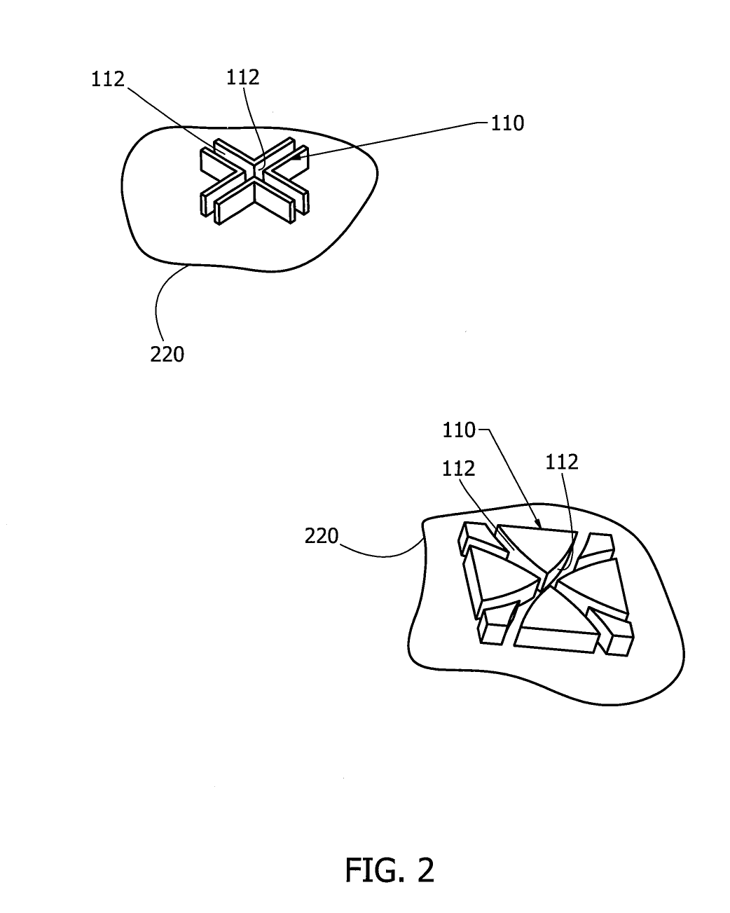

Supports 110 are preferably in the general shape of a “+” symbol with an opening 112 located therein for receipt of an end of column wall 130 as described in greater detail below and best shown in FIGS. 1 and 2. More specifically, two different potential embodiments of supports 110 and openings 112 are depicted in FIG. 2, although it is contemplated that supports 110 and openings 112 can be of different geometric or non-geometric shapes without affecting the overall concept of the present invention provided said supports 110 and openings 112 are capable of supporting column 120 as described herein.

Supports 110 are preferably constructed of plastic, though it is contemplated that any other suitable material, such as rubber or the like, could also be used without affecting the overall concept of the present invention. Supports 110 can be removably or permanently attached to the floor or bottom portion 220 of an aquarium 200 in spaced apart fashion by any common means known in the art including, without limitation, with glue, epoxy, suction, etc. Alternatively, supports 110 can come pre-attached to floor insert or false floor (not shown) that can be manufactured and sold to consumers for covering the bottom portion of an existing aquarium 200 of virtually any size. Supports 110 can be used to hold column 120 in a desired location along the bottom portion 220 of aquarium 200 as described more fully below.

Each column wall 130 further comprises an exterior surface 140 and an interior surface 150, and at least one opening 190 located in column wall 130 that extends between said exterior surface 140 and said interior surface 150. Opening 190 not only prevents the fish located within the column exterior 170 from accessing the column interior 160 and vice versa, but it also permits the water 210 in the aquarium 200, and the oxygen associated therewith, to flow freely from the column exterior portion 170 to column interior portion 160 and vice versa.

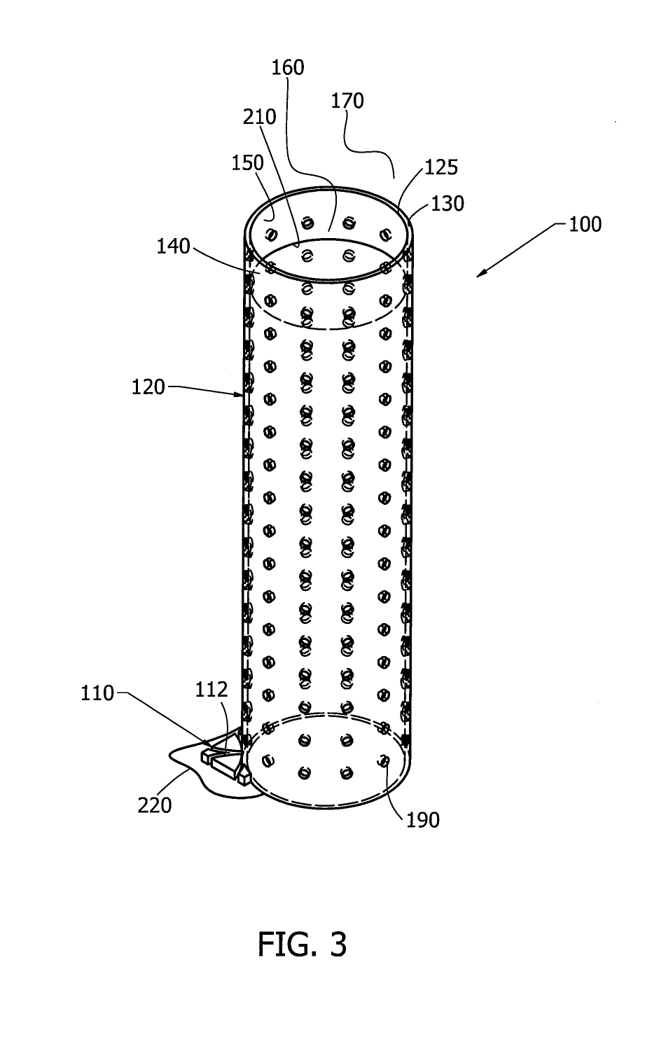

FIG. 3 illustrates a second embodiment of a device 100 for partitioning a portion of an aquarium 200 to separate aggressively natured fish, including betta fish. Device 100 also permits the water 210 within the aquarium 200 to flow freely between the column interior 170 and column interior 160, thereby allowing fish 400 to be maintained in both the column interior portion 160 and column exterior portion 170. Similar to the embodiment of the device 100 depicted in FIG. 1, the device 100 depicted in FIG. 2 also comprises at least one support 110 and at least one column 120 further comprising a column wall 130 for portioning the aquarium or tank 200 into a column interior portion 160 and a column exterior portion 170. In FIG. 3, the cross section of column 120 is substantially circular though, as previously mentioned, it is contemplated that the cross section could take on virtually any geometric or non-geometric shape, such as an oval, square, triangle and the like, without affecting the overall concept of the present invention.

Each of column walls 130 is preferably constructed of a substantially transparent plastic to enable a user or the fish to view objects on the opposite side of said column wall 130. As previously mentioned, the overall geometric configuration and size of column 120 can be manufactured to any user's specification, but are preferably of sufficient width to fit within an aquarium 200 and of sufficient height, as measured from the bottom portion 220 of aquarium 200 upward, to extend above the water level 210 of aquarium 200 to prevent fish 400 from passing over column wall 130. In a preferred embodiment of the present invention, column 120 extends above the water surface 210 by approximately ½ an inch to prevent the fish from jumping or passing over the column wall 130.

As previously mentioned and as an important feature of the present invention, column wall 130 further comprises at least one and preferably a plurality of openings 190 located therein between exterior surface 140 and interior surface 150, as best illustrated in the attached drawings. Openings 190 allow the water, including the oxygen and nutrients contained therein, in the aquarium 200 to move freely through column wall 130, the importance of which will be further described below. Openings 190 are preferably generally circular in shape and sized between 1/16 to ⅜ of an inch in diameter, although it is contemplated that other shapes and sizes could also be used without affecting the overall concept of the invention provided that the openings 190 are small enough to prevent fish 400 from being able to move between the column interior 160 and column exterior 170 through opening 190.

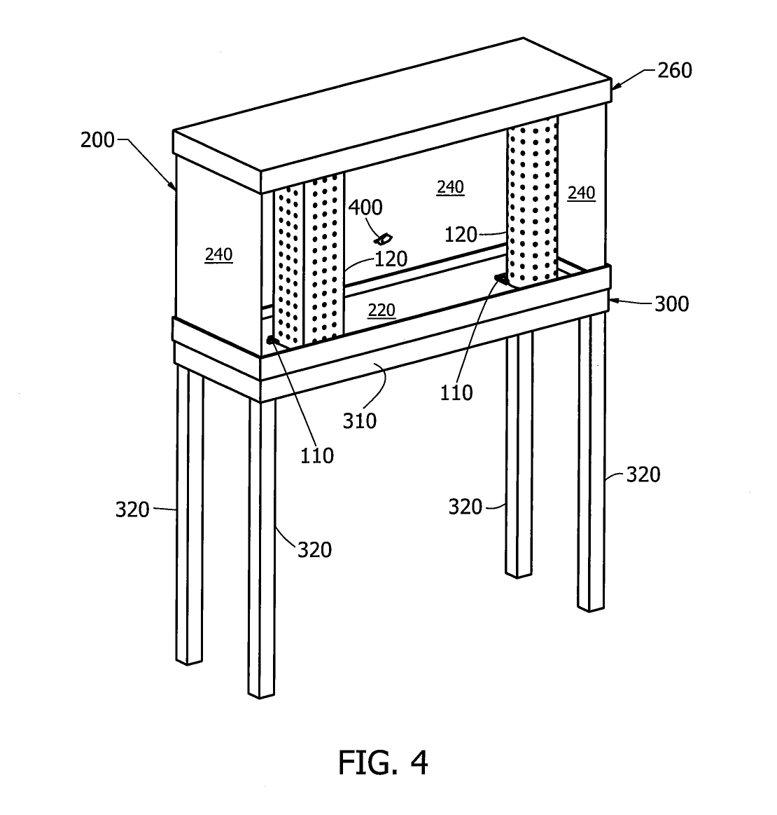

Now that the individual components of device 100 have been described, the interaction of said components and a few of the myriad of potential embodiments of device 100 will now be described. FIG. 4 illustrates an aquarium 200 comprised of a bottom portion 220, a plurality of side portions 240, and a top portion 220, wherein aquarium 200 is resting on a stand 300 that is further comprised of a top 310 and a plurality of legs 320. FIG. 4 further illustrates a plurality of supports 110 positioned in spaced apart fashion along the surface of the bottom portion 220 of aquarium 200.

FIG. 4 also illustrates two possible embodiments of device 100 in spaced apart fashion along, and extending upward from, bottom portion 220 of aquarium 200. More specifically, each of devices 100 are attached to a support 110 by placing the end of the column wall 130 into opening 112 of support 110. As previously mentioned, openings 112 are preferably constructed to matingly engage one end of column wall 130 with a substantially rectangular cross section as best illustrated in FIG. 1. Nonetheless, as also previously mentioned, it is contemplated that the cross section of column 120 could take on many different geometric or non-geometric shapes. Therefore, it is also contemplated that the general shape of support 110, and the size of opening 112 therein, should correspond to the cross section of column 120. Each of openings 112 should also be sized to correspond to the thickness of the column wall 130, as measured from interior surface 150 to exterior surface 140, so as to create a friction fit when one end of column 120 is inserted into opening 112, thereby permitting support 110 to removably retain column 120 in a desired location within aquarium 200.

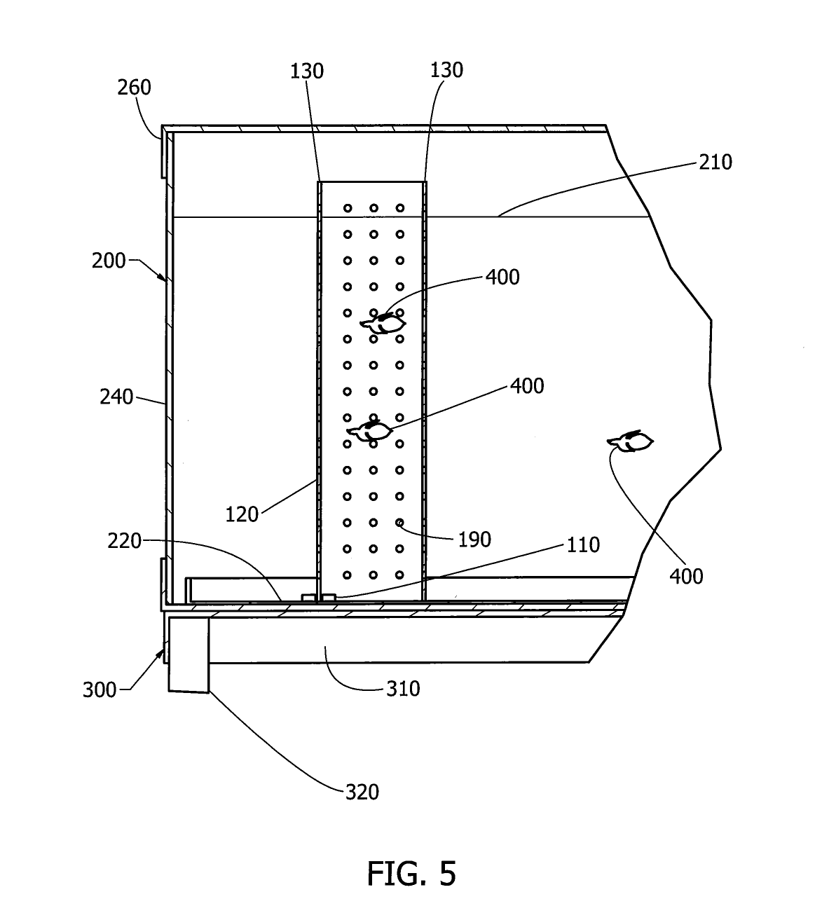

FIG. 5 illustrates a partial front elevational view of one embodiment of device 100 contained within an aquarium 200, wherein said aquarium 200 is resting atop a stand 300. FIG. 5 also illustrates a plurality of fish 400, some of which are positioned within the column interior 160, and at least one of which is positioned in the column exterior portion 170 of aquarium 200. Moreover openings 190 in column wall 130 permit the water level 210 and the quality of the water contained within aquarium 200 to be substantially the same in both the column interior 160 and column exterior 170 including, without limitation, temperatures, oxygen levels, etc.

As an important aspect of the present invention, fish 400 cannot move freely between column interior portion 160 and column exterior portion 170 of aquarium 200, which allows both aggressively natured fish, such as betta fish, and non-aggressive fish to be housed in the same aquarium 200. Further, not only does device 100 eliminate the need for additional aquariums, but it also eliminates the need for all of the accoutrements that typically accompany said additional aquariums including, without limitation, separate heaters, filters, oxygen devices, chemicals, tank ornamentation, etc.

Additionally, it is also contemplated that column 120 can come in two separate halves that can be easily attached to one other by the consumer or user by any common means known in the art such as a latch, hinges, snap together components, etc. By offering column 120 in two separate halves, it is anticipated that a manufacturer can reduce the amount of packaging required for device 100, and thereby improve, manufacturing, warehousing and shipping efficiencies.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device for use in an aquarium containing water therein comprising:
at least one support attached to a bottom portion of the aquarium;
at least one column attached to said at least one support, wherein said at least one column is used to partition said aquarium into a column interior portion and a column exterior portion and said at least one column further comprises a column wall; and
at least one opening in said column wall.

2. The device of claim 1, wherein said column wall is comprised of a substantially transparent material.

3. The device of claim 1, wherein said at least one column is substantially rectangular in cross -section.

4. The device of claim 1, wherein said at least one column is substantially circular in cross-section.

5. The device of claim 1, wherein said aquarium further comprises a water level contained therein, and at least one of said at least one column extends beyond the water level.

6. The device of claim 1, wherein the diameter of at least one of said at least one opening in said column wall is at least 1/16^{th} of an inch.

7. The device of claim 1, wherein the level of the water contained in said column interior portion is substantially the same as the level of the water contained in the column exterior portion.

8. A device for use in an aquarium with water contained therein comprising:
at least one support attached to a bottom portion of the aquarium;
at least one column attached to said at least one support, wherein said at least one column is used to partition said aquarium into a column interior portion and a column exterior portion.

9. The device of claim 8, wherein said at least one column is comprised of a substantially transparent material.

10. The device of claim 8, wherein said at least one column is substantially rectangular in cross -section.

11. The device of claim 8, wherein said at least one column is substantially circular in cross-section.

12. The device of claim 8, wherein at least one of said at least one column extends beyond the level of said water in said aquarium.

13. The device of claim 8, wherein the level of the water contained in said column interior portion is substantially the same as the level of the water contained in the column exterior portion.

14. A device for use in an aquarium with water contained therein comprising:
at least one support attached to a bottom portion of the aquarium;
at least one column attached to said at least one support, wherein said at least one column is used to partition said aquarium into a column interior portion and a column exterior portion and said at least one column further comprises a column wall; and
at least one opening in said column wall extending between an exterior surface of said column wall and an interior surface of said column wall thereby permitting said water to move through said at least one opening in said column wall.

15. The device of claim 14, wherein said column wall is comprised of a substantially transparent material.

16. The device of claim 14, wherein said at least one column is substantially rectangular in cross -section.

17. The device of claim 14, wherein said at least one column is substantially circular in cross-section.

18. The device of claim 14, wherein said at least one column extends beyond the level of said water in said aquarium.

19. The device of claim 14, wherein the diameter of at least one of said at least one opening in said column wall is at least 1/16^{th} of an inch.

20. The device of claim 14, wherein the level of the water contained in said column interior portion is substantially the same as the level of the water contained in the column exterior portion.
